(19) United States
(12) Patent Application Publication
(10) Pub. No.: US 2022/0264593 A1
(43) Pub. Date: Aug. 18, 2022

(54) METHOD, SYSTEM AND DEVICE OF WIRELESS COMMUNICATION

(71) Applicant: SPREADTRUM COMMUNICATIONS (SHANGHAI) CO., LTD., Shanghai (CN)

(72) Inventor: Tingting WANG, Shanghai (CN)

(21) Appl. No.: 17/732,856

(22) Filed: Apr. 29, 2022

Related U.S. Application Data
(63) Continuation of application No. PCT/CN2020/113293, filed on Sep. 3, 2020.

(30) Foreign Application Priority Data
Oct. 29, 2019 (CN) 201911037264.3

(51) Int. Cl. H04W 72/12

(52) U.S. Cl. CPC H04W 72/1231; H04W 72/1242; H04W 72/1268

(57) ABSTRACT

Methods, system, and devices are disclosed for resource control for wireless communication applications. In one aspect of the disclosure, a method for communicating between a network access device and a user equipment (UE) comprises receiving, by the UE, indication information from the network access device, the indication information indicating a target resource. The method further comprises transmitting, by the UE, uplink data to the network access device on the target resource based on the target resource overlapping with a measurement gap in time domain.

### CLAIM OF PRIORITY

This application is a continuation of International Application No. PCT/CN2020/113293, filed Sep. 3, 2020, which claims the benefit of priority to Chinese Patent Application No. 201911037264.3, filed on Oct. 29, 2019. The disclosures of the aforementioned applications are hereby incorporated by reference in their entireties.

### TECHNICAL FIELD

The present disclosure relates to the field of wireless communication and, more specifically, to resource control methods, system, apparatus and computer-readable medium.

### BACKGROUND

In wireless communication technologies, the network configures a user equipment (UE) to measure downlink channel quality and report the measurement results. The UE may be configured to perform intra-frequency, inter-frequency, and/or inter-RAT (short for radio access technology) measurements. The measurements may be carried out in measurement gaps, which are specific time periods configured by the network.

Limited by the current technologies, the UE is prohibited from transmitting uplink data (except the information for initial access) in measurement gaps. As such, when configured resources for uplink data transmission collide with the measurement gaps in time domain, the UE cannot transmit the uplink data on the configured resources, which causes latency of the data transmission and therefore affects user experiences. Further, when the data transmission is associated with a service having strict low-latency requirements, the delay of the data transmission due to the aforementioned collision may cause the latency requirements for the service unable to be satisfied.

### SUMMARY

Methods, system, and devices are disclosed for resource control for wireless communication applications.

In an aspect of the disclosure, a method for communicating between a network access device and a user equipment (UE) is provided. The method comprises receiving, by the UE, indication information from the network access device, the indication information indicating a target resource. The method further comprises transmitting, by the UE, uplink data to the network access device on the target resource based on the target resource overlapping with a measurement gap in time domain.

In one aspect of the disclosure, a user equipment (UE) for communicating with a network access device is provided. The UE comprises at least one processor coupled to a memory and configured to receive indication information from the network access device, the indication information indicating a target resource and transmit uplink data to the network access device on the target resource based on the target resource overlapping with a measurement gap in time domain.

In one aspect of the disclosure, a non-transitory computer-readable medium storing computer executable code is provided. The computer executable code can be executed to receive indication information from the network access device, the indication information indicating a target resource and transmit uplink data to the network access device on the target resource based on the target resource overlapping with a measurement gap in time domain.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

The subject technology will be described in even greater details below based on the exemplary figures, but is not limited to the examples. All features described and/or illustrated herein can be used alone or in different combinations. The features and advantages of various examples will become apparent by reading the following detailed description with reference to the attached drawings which illustrate the following:

FIG. 1 illustrates an exemplary wireless communication system, in accordance with one or more examples of the present disclosure.

FIG. 2 illustrates an exemplary process for resource control, in accordance with one or more examples of the present disclosure.

FIG. 3 illustrates an exemplary process for resource control, in accordance with one or more examples of the present disclosure.

FIG. 4A illustrates an exemplary apparatus for resource control, in accordance with one or more examples of the present disclosure.

FIG. 4B illustrates an exemplary apparatus for resource control, in accordance with one or more examples of the present disclosure.

FIG. 5 illustrates an exemplary device for resource control, in accordance with one or more examples of the present disclosure.

FIG. 6 illustrates an exemplary device for resource control, in accordance with one or more examples of the present disclosure

### DETAILED DESCRIPTION

Various embodiments in the present disclosure provide solutions to resolve collisions between configured resources and measurement gaps, so as to improve latency and reliability in data transmission and efficiency in resource allocation. Indication information of a target resource as well as additional configuration information may be utilized by a network access device and/or a user equipment (UE) in a communication system to determine whether to preserve or terminate a data transmission on a configured resource that collides with a measurement gap in time domain. In some examples, the network access device may determine the collision resolution based on evaluation of the collision impact. In some examples, the network access device and/or the UE may determine the collision resolution based on various threshold values, which may be predefined by the network, the network access device, and/or associated with the channel conditions.

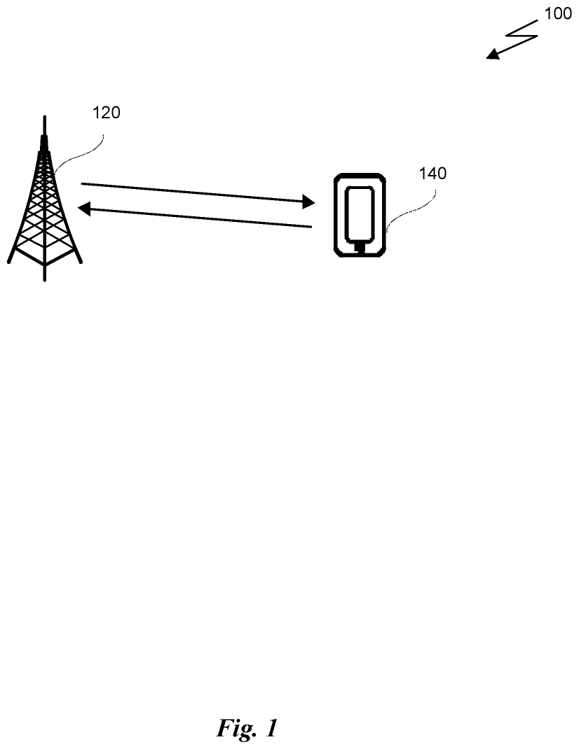

FIG. 1 illustrates a diagram of an exemplary communication system 100, in accordance with one or more examples of the present disclosure.

Communication system 100 may be a Long-Term Evolution (LTE) system, a fifth generation (5G) system, a next-generation wireless communication system of 5G, or any other suitable communication systems. A 5G system may also be referred to as a New Radio (NR) system. Communication system 100 may be applicable to different network architectures, including but not limited to a relay network architecture, a dual link architecture, a V2X architecture, and the like.

As depicted in FIG. 1, communication system 100 may include a network access device(s) 120 and a user equipment(s) (UE) 140. Network access device 120 may be a base station (BS) deployed in a radio access network (RAN), or other types of radio access devices. For example, the base station embodied in the present disclosure may be a base transceiver station (BTS) deployed in the second-generation (2G) network, a node B base station (NodeB) deployed in the third-generation (3G) network, an evolved NodeB (eNB) deployed in the fourth-generation (4G) network, a next generation NodeB (gNB) deployed in the 5G network, or a further evolved NodeB (i.e., ng-eNB). For another example, network access device 120 may be an access point (AP) in wireless local area networks (WLAN). Additionally and/or alternatively, network access device 120 may include one or more devices that provide functions of base stations in future radio access technologies. For instance, network access device 120 may include a home base station (Home eNB or HeNB), a relay, a picocell (Pico), etc.

Network access device 120 may connect UE 140 to a network. The network in the embodiments of the present disclosure refers to a communication network that provides communication services for UE 140. The network may include base stations, controllers of base station controllers, switches, routers, or other devices/facilities in the network.

The network may include one or more core networks, such as an evolved packet core (EPC), a 5G core network, or a new type of core network in future communication systems. A 5G core network may include a set of devices, which implement Access and Mobility Management Function (AMF) for functions such as mobility management, User Plane Function (UPF) for functions such as packet routing and forwarding and quality of service (QoS) managements, Session Management Function (SMF) for functions such as session management, IP address allocation and management, etc. An EPC may include Mobility Management Entity (MME) providing functions such as mobility management, gateway selection, etc., Serving Gateway (S-GW) providing functions such as data packet forwarding, and Packet Data Network (PDN) Gateway (P-GW) providing functions such as terminal address allocation and rate control.

Network access device 120 and UE 140 may establish a wireless connection through a wireless air interface (e.g., an air interface). In some examples, the air interface may be an air interface based on the 4G standard (e.g., LTE), or the 5G standard (e.g., a 5G NR), or a next-generation of the 5G standard. The network access device 120 may receive uplink data sent by UE 140 through the wireless connection.

UE 140 may refer to a device that performs data communication with network access device 120. UE 140 may communicate with one or more core networks via a wireless connection established between UE 140 and network access device 120. UE 140 may be embodied as various forms such as a user equipment, an access device, a subscriber unit, a subscriber station, a mobile station (MS), a remote station, a remote user equipment, a mobile device, a terminal equipment, a wireless communication equipment, a user agent or user equipment, or any combination thereof. UE 140 may also be a cellular telephone, a cordless telephone, a Session Initiation Protocol (SIP) telephone, a Wireless Local Loop (WLL) station, a Personal Digital Assistant (PDA), a wireless Communication-enabled handheld device, a computing/processing device connected to wireless modems, an in-vehicle device, a wearable device, a user equipment in future 5G networks or future evolved Public Land Mobile Networks (PLMNs), etc. It will be appreciated that the type of device embodied as UE 140 is not limited in the present disclosure.

It should be noted that when communication system 100 as shown in FIG. 1 is embodied as a 5G system or a mobile communication technology system in the next-generation of 5G, the above-mentioned network elements may refer to different terminologies, but have the same or similar functions, which are not limited in the present disclosure. Moreover, network access device 120 as shown in FIG. 1 may refer to one or more access network devices, and UE 140 as shown in FIG. 1 may refer to one or more UEs in communication system 100.

Relevant communication processes and related terminologies are described as follows for ease of understanding the technologies disclosed in the present disclosure.

1. Uplink (UL) Dynamic Scheduling: refers to a process of a network access device transmitting an UL Grant to a UE through a Downlink Control Information (DCI). The UL Grant indicating a Physical Uplink Shared Channel (PUSCH) to be transmitted by the UE.

2. Uplink Grant Free Scheduling: enables transmission without grant (TWG). In this process, a network access device provides UL grant configuration to a UE when activating Uplink Grant Free Scheduling for the UE. The UE can keep using the UL grant configuration for UL transmissions until receiving a deactivation of the Uplink Grant Free Scheduling from the network access device. There are two types of Uplink Grant Free Scheduling, which are configured grant Type 1 (or TWG Type 1) and configured grant Type 2 (or TWG Type 2).

Configured grant Type 1: uplink grant configuration and activation/deactivation provided by Radio Resource Control (RRC) signaling.

Configured grant Type 2: uplink grant configuration provided via RRC signaling, and activation/deactivation provided via Physical Downlink Control Channel (PDCCH) grant (via DCIs).

In both the configured grant Type 1 and 2, RRC signaling configures Bandwidth Parts (BWPs) per serving cell (e.g., network access device 120 as shown in FIG. 1).

When the configured grant Type 1 is configured, RRC signaling configures the following parameters:

(1) Configured-Scheduling Radio Network Temporary Identifier (CS-RNTI): indicating CS-RNTI being used to scramble Uplink Grant for retransmission;

(2) periodicity: indicating periodicity of the configured grant Type 1;

(3) time domain offset: indicating an offset of a resource relative to a subframe numbered zero (SFN=0) in the time domain;

(4) time domain allocation: indicating configuration of resources allocated for Uplink Grant in the time domain, the configuration including a start symbol and a length of the resource; and

(5) a number of Hybrid Automatic Repeat reQuest (HARQ) processes: indicating the number of HARQ processes of the configured resources.

When the configured grant Type 2 is configured, RRC signaling configures the following parameters:

(1) CS-RNTI: indicating CS-RNTI used for activation/deactivation, and transport block (TB) for retransmissions;

(2) periodicity: the period of pre-configured authorization type 2; and

(3) a number of HARQ processes: indicating the number of HARQ processes of the configured resources.

The resources indicated by the above-mentioned configured grant Type 1 and configured grant Type 2 are all periodic resources.

Configured resources can be used to transmit periodic services or aperiodic services. The configured resources support configurations and activations of multiple sets of configured resources on a given BWP on a serving cell, so as to support a variety of different types of services, as well as enhance transmission reliability and reduce transmission latency.

The network may configure the user equipment to measure the downlink channel quality and report the measurement result. The measurements can be intra-frequency, inter-frequency, or inter-RAT. The network may configure a measurement gap(s) for the user equipment to perform such measurements, based on capabilities of the user equipment.

A measurement gap occurs periodically. The network may configure the length, the repetition period and/or the offset of the measurement gap. The offset may indicate the starting position of the measurement gap. The length of the measurement gap may be of different values and is not limited in the present disclosure. For example, the measurement gap may be set with a minimum length of 1.5 milliseconds, and/or a maximum length of 6 milliseconds.

In the existing technologies, a user equipment is configured to solely perform measurements during a measurement gap. During the measurement gap, the user equipment may transmit information associated with initial accesses, however, is prohibited from transmitting any other uplink data. In this way, when a resource allocated for an uplink data transmission collides with the measurement gap in time domain, the uplink data cannot be transmitted on the configured resource, thus causing latency for the uplink data transmission. Such situation is especially harmful to services having strict low-latency requirements. For example, certain Telecommunications and Network (TSN) services or Ultra Reliable Low Latency Communication (URLLC) services may require a latency on the user plane to be as low as 0.5 milliseconds and meanwhile require a high reliability for data transmissions (e.g., few interruptions of data transmissions). However, when the uplink data cannot be transmitted due to the aforementioned collisions, the communication system may not be able to meet the low-latency requirements of the services.

To this end, embodiments of the present disclosure provide resource control methods, devices, and apparatuses, enabling transmissions of uplink data on allocated resources that are colliding with measurement gaps in time domain, thereby reducing latency and improving reliability in data transmissions as well as improving efficiency of resource utilization, so as to improve user experience in wireless communications.

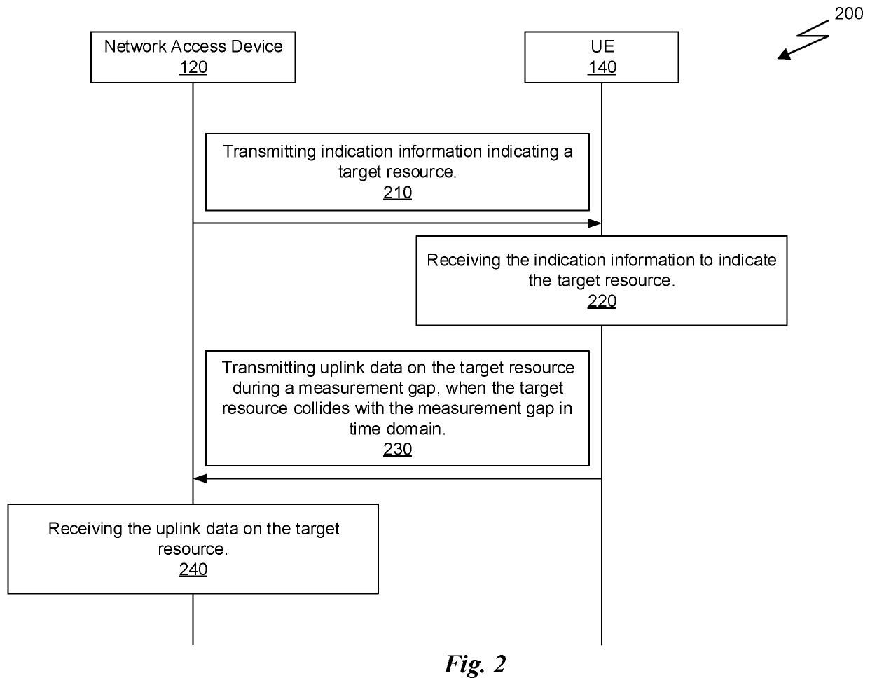

FIG. 2 illustrates an exemplary process 200 for resource control, in accordance with one or more embodiments of the present disclosure. Process 200 may be performed by network access device 120 and UE 140 included in communication system 100 as shown in FIG. 1.

At Step 210, the network access device transmits indication information to the UE. The indication information may indicate a target resource. The network access device may configure resources for the UE, and set at least one configured resource as the target resource for the UE. The target resource may be a periodic resource. In some examples, the target resource may include a configured grant (CG) resource and/or a semi persistent scheduling (SPS) resource that is allocated for the UE. In some instances, the target resource may include a CG Type 1 and/or CG Type 2 resource.

At Step 220, the UE receives the indication information from the network access device to indicate the target resource. The indication information indicates at least one target resource.

At Step 230, the UE transmits uplink data on the target resource to the network access device during a measurement gap, when the target resource collides with the measurement gap in time domain. The network access device may configure measurement gaps for the UE, including lengths, periodicities and other parameters. Then, the network access device may signal the configurations of the measurement gaps to the UE. The indication information and the configuration information may be signaled to the UE separately or in a combined message. When the UE enters a time period associated with a measurement gap, the UE as configured in the present disclosure may determine whether to preserve or terminate data transmissions scheduled in the measurement gap so as to improve overall performance of the communication system by reducing latency, improving reliability and efficiency.

In some examples, the network access device and/or the UE may determine whether to preserve/terminate a data transmission on a target resource in a measurement gap based on the length of the target resource and the length of the measurement gap. The network access device may configure both the target resource and the measurement gap for the UE. A collision will occur when at least a portion of the target resource overlaps with the measurement gap in time domain. As an example, the network access device may configure a relatively long length for the measurement gap and a comparably short length for the target resource. In this example, even under the worst situation when the entire target resource overlaps with the measurement gap, the ratio of the collision duration to the measurement gap can be considerably small, thus negligibly affecting measurements taking place in the measurement gap. To this end, the network access device and/or the UE may determine to preserve the transmission of data on the target resource.

In further embodiments, the network access device and/or the UE may predefine a first threshold length for a measurement gap, a second threshold length for a target resource, and/or a threshold periodicity for the target resource, so as to determine whether to preserve/terminate a data transmission on a target resource in a measurement gap. The network access device and/or the UE may determine to preserve a data transmission on the target resource in the measurement gap when at least one of the following conditions being satisfied. First, the length of the measurement gap is greater than the first threshold length. Second, the length of the target resource is less than the second threshold length. Third, the periodicity of the target resource is greater than the threshold periodicity. As an example, when the first length is set to be 6 milliseconds and the second length is set to be two symbols (e.g., 66.7 microseconds per symbol), data transmissions to be preserved will have a ratio of a potential collision to the measurement gap being less than 0.0111.

In some embodiments, the uplink data may refer to data packets arrival at the UE side, which have a fixed offset, periodicity, and size.

In some embodiments, the uplink data may have strict requirements on latency. For instance, the uplink data may be associated with a service that is predefined with a threshold latency, such as 0.5 milliseconds. The uplink data has to be transmitted with a latency lower than the threshold latency to meet the latency requirement. To this end, the network access device and/or the UE may take into account the latency requirement (e.g., the latency threshold) in order to determine whether to preserve/terminate uplink data transmission in a measurement gap.

At Step 240, the network access device receives the uplink data on the target resource. When determining to preserve the uplink data transmission on the target resource, the network access device may preserve the target resource for the UE and receive the uplink data on the target resource in the measurement gap.

As the foregoing illustrates, the network access device configures measurement gaps and resources for the UE, such that the network access device perceives an overall pattern of the measurement gaps and the configured resources. In other words, the network access device has the knowledge of the time-frequency distribution of all resources. Therefore, the network access device may evaluate the impact of a collision caused by one or more resources overlapping with a measurement gap, based on the distribution of the overall pattern for the one or more resources and the measurement gap. To this end, the network access device may determine whether to preserve data transmissions on the one or more resources in the measurement gap based on the evaluation.

In some embodiments, the network access device may determine a number of configured resources having negligible impacts on measurements scheduled in measurement gaps. As such, the network access device may configure a target resource as one or more resources among the number of configured resources for the UE. The network access device and the UE may make an agreement that when the target resource collides with a measurement gap in time domain, the UE may preserve uplink data transmission on the target resource in the measurement gap, and the network device may receive the uplink data transmitted on the target resource from the UE.

To summarize, the UE receives indication information to indicate a target resource, which can be used for uplink data transmissions even if the target resource collides with a measurement gap in time domain. In this way, the UE can experience less transmission latency, thereby improving reliability of the data transmission and efficiency of the resource utilization.

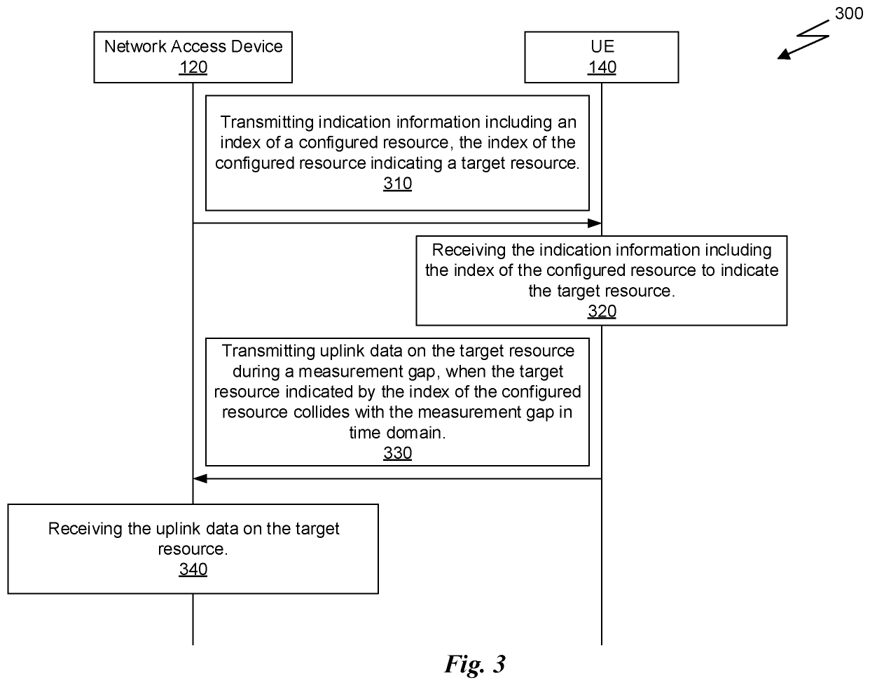

FIG. 3 illustrates an exemplary process 300 for resource control, in accordance with one or more embodiments of the present disclosure. Process 300 may be performed by network access device 120 and UE 140 included in communication system 100 as shown in FIG. 1.

At Step 310, the network access device transmits indication information including an index of a configured resource (referred to as configured resource index) to the UE. The index of the configured resource indicates a target resource.

In some variations, the indication information may include indices of a set of configured resources, which are set to be the target resource. When the target resource include a set of configured resources, the indices of the set of configured resources may be carried in the indication information in the form of a list. The list of indices may be associated with multiple configured resources in a one-to-one manner. Each index may indicate a configured resource that can be set as a target resource.

In some embodiments, the network access device may transmit the indication information to the UE in a dedicated signaling. Alternatively, the network access device may transmit the indication information in combination with a message indicating other configuration information, such as a message indicating a measurement configuration, or a message indicating a measurement gap configuration (i.e., MeasGapConfig).

In some embodiments, the indication information may include a threshold value corresponding to the signal quality and/or a threshold value corresponding to the logical channel priority (or channel priority). The threshold value corresponding to the signal quality and/or the threshold value corresponding to the logical channel priority may be configured by the network access device, or predefined by the standard.

In some examples, the threshold value corresponding to the signal quality may be defined as a minimum value (e.g., s-MeasureConfig) for performing a measurement of reference signal receiving power (RSRP). In some examples, the UE may perform the measurement of RSRP for the intra-frequency or inter-RAT system.

At Step 320, the UE receives the indication information from the network access device to indicate the target resource. The UE may determine the target resource based on the index of the configured resource included in the indication information.

In some embodiments, the UE may receive the indication information via a dedicated signaling. Alternatively, the UE may obtain the indication information from a message carrying additional configuration information, such as the measurement configuration and/or the measurement gap configuration. The UE may also obtain threshold values corresponding to the signal quality and/or channel priority from the indication information.

At Step 330, the UE transmits uplink data on the target resource to the network access device during a measurement gap, when the target resource indicated by the index of the configured resource collides with the measurement gap in time domain.

When the indication information includes a threshold value corresponding to the signal quality, such as a threshold for performing the measurement of RSRP, the UE may determine whether to preserve the data transmission in view of the collision based on the threshold for performing the measurement of RSRP. For instance, the UE may determine to preserve the data transmission on the target resource in response to the measured signal power being greater than the threshold value. Otherwise, the UE may determine to terminate the data transmission on the target resource in response to the measured signal power being less than or equal to the threshold value.

When the indication information includes a threshold value corresponding to the channel priority, the UE may determine whether to preserve the data transmission in view of the collision based on the threshold priority. For example, the UE may compare the priority of the channel to be transmitted on the target resource with the threshold priority. Then, the UE may determine to preserve the data transmission on the target resource in response to the highest priority of the channel being higher than the threshold priority. Otherwise, the UE may determine to terminate the data transmission on the target resource in response to the highest priority of the channel being lower than or equal to the threshold priority. The highest priority of the logical channel may be associated with the data currently stored in a buffer, which is ready to be transmitted on the target resource. In some variations, the priority of the logical channel may decrease when the amount of data stored in the buffer associated with the logical channel decreases. In some examples, the priority of the logical channel may also be influenced by the type of service associated with the data, as well as other settings (e.g., data rate) in the communication system.

In some examples, the UE may determine whether to preserve the data transmission in view of the collision based on any of the aforementioned threshold values or any combination thereof. To illustrate, the UE may obtain threshold values corresponding to the signal quality and channel priority from the indication information. In one example, the UE may determine to preserve the data transmission on the target resource in response to the measured signal power being greater than the threshold value and the highest priority of the channel being higher than the threshold priority. Otherwise, the UE may determine to terminate the data transmission on the target resource in response to the measured signal power being less than or equal to the threshold value or the highest priority of the channel being lower than or equal to the threshold priority. In another example, the UE may determine to preserve the data transmission on the target resource in response to the measured signal power being greater than the threshold value or the highest priority of the channel being higher than the threshold priority. Otherwise, the UE may determine to terminate the data transmission on the target resource in response to the measured signal power being less than or equal to the threshold value and the highest priority of the channel being lower than or equal to the threshold priority.

At Step 340, the network access device receives the uplink data on the target resource. The network access device preserves the target resource in time domain for the UE and receives the uplink data on the target resource from the UE, despite the collision between the target resource and the measurement gap in time domain.

As described in process 300, the network access device and the UE may determine how to resolve collisions between a target resource and a measurement gap based on information related to the channel, such as the signal quality and/or the priority of the channel. The aforementioned process 200 and 300, alone or in combination, provide for flexible resource control methods, thereby reducing latency and improving reliability of the data transmission, as well as improving efficiency of the resource utilization.

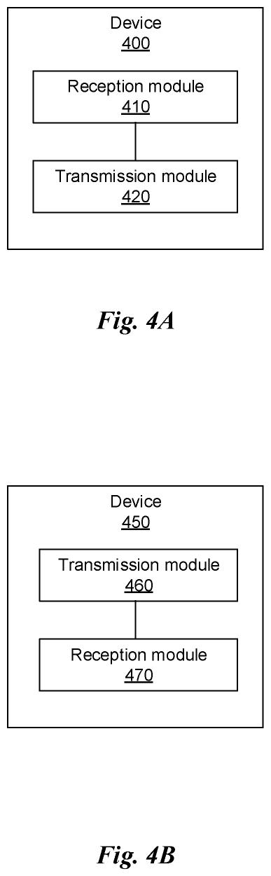

FIG. 4A illustrates an exemplary apparatus 400 for resource control, in accordance with one or more embodiments of the present disclosure. Apparatus 400 may be included in UE 140 in communication system 100 as shown in FIG. 1, and enable UE 140 to perform steps as described in process 200 and 300 as shown in FIGS. 2 and 3, respectively. As shown in FIG. 4A, apparatus 400 may include a reception module 410 and a transmission module 420. Each of reception module 410 and transmission module 420 may include hardware (e.g., circuits, chips, or semiconductor modules), software, or a combination thereof.

Reception module 410 may be configured to receive indication information. The indication information may indicate a configured resource as a target resource. In some embodiments, the indication information may include a list of indices associated with a set of configured resources. The target resource may include the set of configured resources indicated by the list of indices. Additionally, and/or alternatively, the indication information may include threshold values corresponding to the channel for data transmission, such as the signal quality or the priority of the channel.

In some examples, reception module 410 may be configured to receive a message including configuration information. The message may be received in a separate signaling from the reception of the indication information. Alternatively, the message may include the indication information.

Transmission module 420 may be configured to transmit uplink data on the target resource, when the target resource collides with a measurement gap in time domain. As mentioned-above, the UE may determine whether to preserve or terminate the uplink data transmission on the target resource in the measurement gap. In response to the uplink data transmission being preserved, transmission module 420 may be configured to transmit the uplink data on the target resource.

FIG. 4B illustrates an exemplary apparatus 450 for resource control, in accordance with one or more embodiments of the present disclosure. Apparatus 200 may be included in network access device 120 in communication system 100 as shown in FIG. 1, and enable network access device 120 to perform steps as described in process 200/300 as shown in FIG. 2/3, respectively. As shown in FIG. 4B, apparatus 450 may include a transmission module 460 and a reception module 470. Each of transmission module 460 and reception module 470 may include hardware (e.g., circuits, chips, or semiconductor modules), software, or a combination thereof.

Transmission module 460 may be configured to transmitted indication information. The indication information may indicate a configured resource as a target resource. In some embodiments, the indication information may include a list of indices associated with a set of configured resources. The target resource may include the set of configured resources indicated by the list of indices. Additionally, and/or alternatively, the indication information may include threshold values corresponding to the channel for data transmission, such as the signal quality or the priority of the channel.

In some examples, transmission module 460 may be configured to transmit a message including configuration information. The message may be transmitted in a separate signaling from the transmission of the indication information. Alternatively, the message may include the indication information.

Reception module 470 may be configured to receive uplink data on the target resource, when the target resource collides with a measurement gap in time domain. As mentioned-above, the network access device may preserve the target resource for the UE, and reception module 470 may receive the uplink data on the target resource.

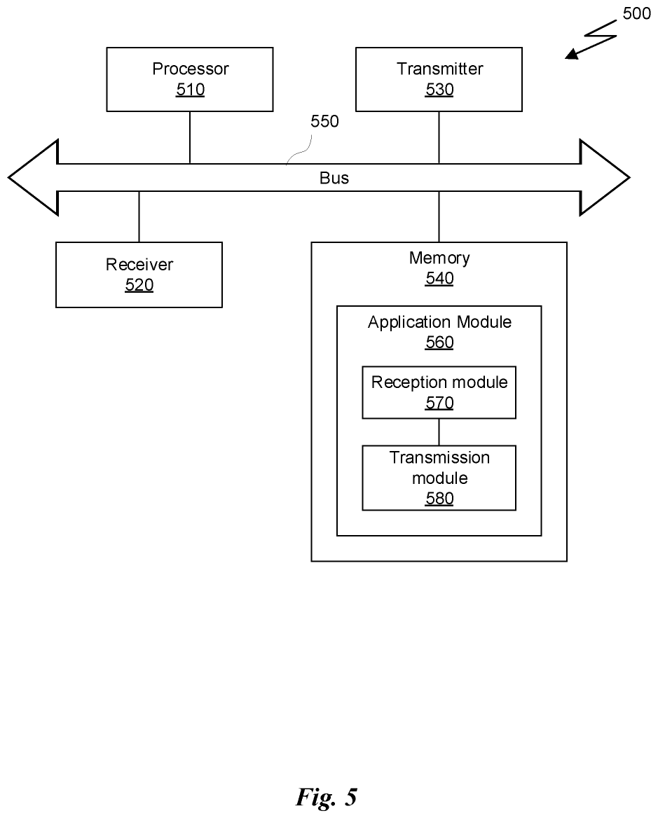

FIG. 5 illustrates an exemplary device 500 for resource control, in accordance with one or more embodiments of the present disclosure. Device 500 may be embodied as UE 140 in communication system 100 as shown in FIG. 1, and perform steps as described in process 200/300 as shown in FIG. 2/3, respectively. As shown in FIG. 5, device 500 may include a processor(s) 510, a receiver 520, a transmitter 530, a memory 540, and a bus 550. Processor 510, receiver 520, transmitter 530 and memory 540 may be connected through bus 550.

Processor 510 may be configured to execute instructions stored in memory 540 so as to perform processes as described in process 200/300 as the UE.

Receiver 520 and transmitter 530 may include hardware, such as communication chips and radio frequency circuits to facilitate transmission and reception processes as described in process 200/300. In some embodiments, receiver 520 and transmitter 530 may be combined as a single wireless component (e.g., a transceiver). The wireless component may include multiple chips, including chips for reception, transmission, and modulation/demodulation of wireless signals as well as chips for other functions.

Memory 540 may be any non-transitory type of storage, such as volatile or non-volatile, magnetic, semiconductor-based, tape-based, optical, removable, non-removable, or other type of storage device or tangible computer-readable medium including, but not limited to, a read-only memory (ROM), a flash memory, a dynamic random-access memory (RAM), and/or a static RAM. Memory 540 may store instructions to be executed by processor 510. In some instances, memory 540 may store instructions for performing the aforementioned process 200/300 in an application module 560. In some variations, apparatus 400 as demonstrated in FIG. 4A may be embodied as software stored in application module 560. Further, reception module 410 of apparatus 400 may be stored as a reception module 570 in application module 560 of memory 540, and transmission module 420 of apparatus 400 may be stored as a transmission module 580 in application module 560 of memory 540.

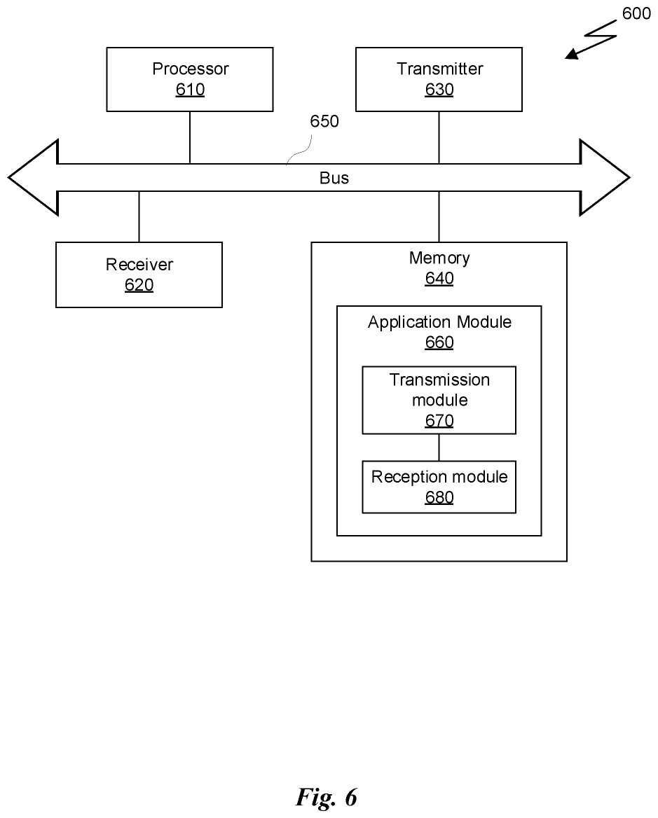

FIG. 6 illustrates an exemplary device 600 for resource control, in accordance with one or more embodiments of the present disclosure. Device 600 may be embodied as network access device 120 in communication system 100 as shown in FIG. 1, and perform steps as described in process 200/300 as shown in FIG. 2/3, respectively. As shown in FIG. 6, device 600 may include a processor(s) 610, a receiver 620, a transmitter 630, a memory 640, and a bus 650. Processor 610, receiver 620, transmitter 630 and memory 640 may be connected through bus 650.

Processor 610 may be configured to execute instructions stored in memory 640 so as to perform processes as described in process 200/300 as the network access device

Receiver 620 and transmitter 630 may include hardware, such as communication chips and radio frequency circuits to facilitate transmission and reception processes as described in process 200/300. In some embodiments, receiver 620 and transmitter 630 may be combined as a single wireless component (e.g., a transceiver). The wireless component may include multiple chips, including chips for reception, transmission, and modulation/demodulation of wireless signals as well as chips for other functions.

Memory 640 may be any non-transitory type of storage, such as volatile or non-volatile, magnetic, semiconductor-based, tape-based, optical, removable, non-removable, or other type of storage device or tangible computer-readable medium including, but not limited to, a read-only memory (ROM), a flash memory, a dynamic random-access memory (RAM), and/or a static RAM. Memory 640 may store instructions to be executed by processor 610. In some instances, memory 640 may store instructions for performing the aforementioned process 200/300 in an application module 560. In some variations, apparatus 450 as demonstrated in FIG. 4B may be embodied as software stored in application module 660. Further, transmission module 660 of apparatus 450 may be stored as a transmission module 670 in application module 660 of memory 640, and reception module 470 of apparatus 450 may be stored as a reception module 680 in application module 560 of memory 540.

A resource control method is provided and used in a user equipment. The method comprises: receiving indication information, where the indication information is used to indicate a target resource, and sending the uplink data on the target resource in the case that a measurement gap collides with the target resource in time domain.

The indication information comprises a configured resource index, and in the case of a conflict between a measurement gap and the target resource in time domain, the sending the uplink data on the target resource includes: in the case that the measurement gap and the target resource indicated by the configured resource index collide in time domain, sending the uplink data on the target resource.

The indication information further comprises a signal quality threshold value corresponding to the signal quality. The sending the uplink data on the target resource, in the case that the measurement gap and the target resource indicated by the configured resource index collide in time domain, further comprises: in the case that the measurement gap and the target resource indicated by the configured resource index collide in time domain, when the measured signal quality is greater than the signal quality threshold value, sending the uplink data on the target resource.

The indication information further comprises a priority threshold value corresponding to a logical channel priority. The sending the uplink data on the target resource, in the case that the measurement gap and the target resource indicated by the configured resource index collide in time domain, further comprises: in the case that the measurement gap and the target resource indicated by the configured resource index collide in time domain, when the highest priority of the logical channel corresponding to the target resource is higher than the priority threshold value, sending the uplink data on the target resource. The highest priority of the logical channel corresponding to the target resource is the highest priority of the logical channel corresponding to the data that exists in the current buffer and can be sent on the target resource.

The indication information further comprises a signal quality threshold value corresponding to the signal quality and a priority threshold value corresponding to a logical channel priority. The sending the uplink data on the target resource, in the case that the measurement gap and the target resource indicated by the configured resource index collide in time domain, further comprises: in the case that the measurement gap and the target resource indicated by the configured resource index collide in time domain, when the measured signal quality is greater than the signal quality threshold value and the highest priority of the logical channel corresponding to the target resource is higher than the priority threshold value, sending the uplink data on the target resource. The highest priority of the logical channel corresponding to the target resource is the highest priority of the logical channel corresponding to the data that exists in the current buffer and can be sent on the target resource.

The receiving indication information further comprises: receiving a measurement configuration message carrying the indication information, receiving a measurement gap configuration message carrying the indication information, or receiving a signaling carrying the indication information.

A resource control method is provided and used in a network access device. The method comprises: sending indication information, where the indication information is used to indicate a target resource, and receiving the uplink data on the target resource in the case that a measurement gap collides with the target resource in time domain.

The indication information further comprises a configured resource index, and the configured resource index is used to indicate the target resource.

The indication information further comprises a signal quality threshold value corresponding to the signal quality and/or a priority threshold value corresponding to a logical channel priority.

A resource control apparatus is provided and used in a user equipment. The apparatus comprises: a reception module, configured to receive indication information, where the indication information is used to indicate a target resource, and a transmission module, configured to send the uplink data on the target resource when a measurement gap collides with the target resource in time domain.

A resource control apparatus is provided and used in a network access device. The apparatus comprises: a transmission module, configured to send indication information, where the indication information is used to indicate a target resource, and a reception module, configured to receive the uplink data on the target resource when a measurement gap collides with the target resource in time domain.

A user equipment is provided for resource control. The user equipment comprises a processor and a memory for storing instructions executable by the processor. The processor is configured to receive indication information, where the indication information is used to indicate a target resource, and sending the uplink data on the target resource in the case that a measurement gap collides with the target resource in time domain.

A network access device is provided for resource control. The network access device comprises a processor and a memory for storing instructions executable by the processor. The processor is configured to transmit indication information, where the indication information is used to indicate a target resource, and receiving the uplink data on the target resource in the case that a measurement gap collides with the target resource in time domain.

A non-volatile computer-readable storage medium is provided for resource control. The non-volatile computer-readable storage medium stores computer program instructions thereon. The computer program instructions implement the method according to any one of the aforementioned processes when the computer program instructions are executed by a processor.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for communicating between a network access device and a user equipment (UE), comprising:
receiving, by the UE, indication information from the network access device, the indication information indicating a target resource;
transmitting, by the UE, uplink data to the network access device on the target resource based on the target resource overlapping with a measurement gap in time domain.

2. The method of claim 1, wherein the indication information further comprise at least one of a threshold value corresponding to signal quality and a priority threshold corresponding to logical channel priority, wherein the UE determines whether to transmit uplink data on the target resource based on the indication information.

3. The method of claim 2, further comprising:
measuring, by the UE, signal quality;
transmitting, by the UE, uplink data to the network access device on the target resource based on the measured signal quality being greater than the threshold value.

4. The method of claim 2, further comprising:
determining, by the UE, the highest priority of the logical channel, wherein the highest priority of the logical channel is the highest priority of the logical channel corresponding to the data currently stored in a buffer, which is ready to be transmitted on the target resource;
transmitting, by the UE, uplink data to the network access device on the target resource based on the determination of the highest priority of logical channel being greater than the priority threshold.

5. The method of claim 2, further comprising:
determining, by the UE, a measured signal quality and the highest priority of the logical channel, wherein the highest priority of the logical channel is the highest priority of the logical channel corresponding to the data currently stored in a buffer, which is ready to be transmitted on the target resource;
transmitting, by the UE, uplink data to the network access device on the target resource based on the determination of the measured signal quality being greater than the threshold value and the highest priority of the logical channel being greater than the priority threshold value.

6. The method of claim 1, wherein the indication information comprise a configured resource index, the configured resource index configured for indicating the target resource.

7. The method of claim 1, wherein the UE obtains at least one of lengths of the measurement gap, periodicities of the measurement gap, a first threshold length of the measurement gap, a second threshold for the target resource, and a threshold periodicity for the target resource.

8. The method of claim 7, further comprising:
transmitting, by the UE, uplink data on the target resource based on the determination that the length of the measurement gap is greater than the first threshold length.

9. The method of claim 7, further comprising:
transmitting, by the UE, uplink data on the target resource based on the determination that the determination of the length of the target resource is less than the second threshold length.

10. The method of claim 7, further comprising:
transmitting, by the UE, uplink data on the target resource based on the determination that the periodicity of the target resource is greater than the threshold periodicity.

11. The method of claim 1, wherein the indication information is included in a message carrying at least one of a measurement configuration and a measurement gap configuration.

12. A user equipment (UE) for communicating with a network access device, comprising at least one processor coupled to a memory and configured to:
receive indication information from the network access device, the indication information indicating a target resource;
transmit uplink data to the network access device on the target resource based on the target resource overlapping with a measurement gap in time domain.

13. The UE of claim 12, wherein the indication information further comprise at least one of a threshold value corresponding to signal quality and a priority threshold corresponding to logical channel priority, wherein the UE determines whether to transmit uplink data on the target resource based on the indication information.

14. The UE of claim 13, further configured to:
measure signal quality;
transmit uplink data to the network access device on the target resource based on the measured signal quality being greater than the threshold value.

15. The UE of claim 13, further configured to:
determine the highest priority of the logical channel, wherein the highest priority of the logical channel is the highest priority of the logical channel corresponding to the data currently stored in a buffer, which is ready to be transmitted on the target resource;
transmit uplink data to the network access device on the target resource based on the determination of the highest priority of logical channel being greater than the priority threshold.

16. The UE of claim 13, further configured to:
determine a measured signal quality and the highest priority of the logical channel, wherein the highest priority of the logical channel is the highest priority of the logical channel corresponding to the data currently stored in a buffer, which is ready to be transmitted on the target resource;
transmit uplink data to the network access device on the target resource based on the determination of the measured signal quality being greater than the threshold value and the highest priority of the logical channel being greater than the priority threshold value.

17. The UE of claim 12, wherein the indication information comprise a configured resource index, the configured resource index configured for indicating the target resource.

18. The UE of claim 12, wherein the indication information is included in a message carrying at least one of a measurement configuration and a measurement gap configuration.

19. A non-transitory computer-readable medium storing computer executable code, comprising code to:
receive indication information from the network access device, the indication information indicating a target resource;
transmit uplink data to the network access device on the target resource based on the target resource overlapping with a measurement gap in time domain.
